(19) United States
(12) Patent Application Publication
(10) Pub. No.: US 2013/0281062 A1
(43) Pub. Date: Oct. 24, 2013

(54) IDENTIFY A RADIO FREQUENCY DEVICE BY MAC ADDRESS SYSTEM AND METHOD

(71) Applicants: Jonathan A. Croy, Seattle, WA (US); Joshua L. Marti, Bellevue, WA (US); Joshua Guilfoyle, Bellevue, WA (US)

(72) Inventors: Jonathan A. Croy, Seattle, WA (US); Joshua L. Marti, Bellevue, WA (US); Joshua Guilfoyle, Bellevue, WA (US)

(73) Assignee: POINT INSIDE, INC., Bellevue, WA (US)

(21) Appl. No.: 13/922,155

(22) Filed: Jun. 19, 2013

Related U.S. Application Data
(63) Continuation-in-part of application No. 13/760,927, filed on Feb. 6, 2013.
Application No. 13/760,927 is a continuation-in-part of application No. 13/656,566, filed on Oct. 19, 2012.
(60) Provisional application No. 61/550,283, filed on Oct. 21, 2011.

(51) Int. Cl. H04W 12/06

(52) U.S. Cl. CPC H04W 12/06
USPC 455/411

(57) ABSTRACT

A computer system reports “logical usage pattern data” and location information in a Device Report; in addition, another computer system reports MAC addresses associated with mobile device in Network Device reports; the Device Reports and Networks Reports are correlated based on various factors; if a set of Device Reports and Network Reports correlate, then a Device Identifier is created and sent to the corresponding mobile device; the Device Identifier may then be used to identify the mobile device, such as when the MAC address is inaccessible. The Device Identifier may be associated with other devices used by the user of the mobile device. Behavioral information associated with all the devices may be obtained and behavioral patterns determined. Content served to the mobile device may then be optimized based on the determined behavioral patterns.

### CROSS-REFERENCE TO RELATED APPLICATIONS

This application is a continuation-in-part of and claims the benefit of priority of U.S. patent application Ser. No. 13/760,927, titled “Identify a Radio Frequency Device by MAC Address System and Method,” filed Feb. 6, 2013, and is a continuation-in-part of and claims the benefit of priority to U.S. patent application Ser. No. 13/656,566, titled “Optimizing the Relevance of Mobile Content Based on Users State of Motion,” filed Oct. 19, 2012, and naming inventor Jonathan A. Croy; U.S. patent application Ser. No. 13/656,566, in turn, claims the benefit of priority to U.S. Provisional Patent Application No. 61/550,283, filed Oct. 21, 2011, which application the present application also claims the benefit of priority to. The above-cited applications are incorporated herein by reference in their entirety, for all purposes.

### FIELD

The present disclosure relates to the field of identification of computers.

### BACKGROUND

The capability to identify individual computer devices is of key importance for the tracking of the device's user. To track devices, companies build computer products with a device identifier or Unique Identifier (UID) that is ensured to be unique among all identifiers used for that object and for a specific purpose. A unique identifier can be a serial number, a set of random numbers, or a combination of names and codes allocated by choice. Examples of unique identifiers are the Organizationally Unique Identifiers (OUID) and Apple's Unique Device Identifier (UDID). Many computer devices are linked to one or more of these identifiers which allows others to not only identify the device, but discriminate that particular device from all other devices. This ability is particularly important for developers to track and record the history of actions for individual devices and therefore the actions of the user.

A device's unique identifier has been used as a means for mobile advertisers and ad networks to count how often users install applications, interact with the applications, and when they view and click on advertisements presented through the applications. This is known as the conversion rate of a particular advertisement and is considered to be the most important performance metric used by advertisers. The unique identifier is used as the integral piece of information in this process as it links the clicking of the advertisement with the download of the application through a hashed version of the UID which each step in the process produces. Hence without a device's unique identifier, the link between click and conversion would be severed and advertisers would not be able to accurately compute their cost per install across different platforms, thereby inhibiting their ability to justify and appropriately target their advertising.

Currently, the chief method of tracking devices and users is through the use of the device's UID (Android) or UDID (Apple) as described previously. However, access to these unique identifiers is being greatly diminished (with the intent to ultimately be eradicated) as companies begin to tighten their privacy policies to protect users from malicious content and unlicensed access to their devices. While developers are currently attempting to implement the use of a different unique device identifier to continue monitoring mobile device users, it can be assumed that any identifier which is unique to the device will be blocked from being accessed by third party applications as it too provides direct access to the device and user. An unintended consequence of this action is that third party applications that rely on unique device identifiers to enable functionality other than advertising will no longer be able to do so.

### BRIEF DESCRIPTION OF THE DRAWINGS

FIG. 1 is a network and device diagram illustrating exemplary computing devices configured according to embodiments disclosed in this paper.

FIG. 2 is a functional block diagram of an exemplary POIN Server computing device and some data structures and/or components thereof.

FIG. 3 is a functional block diagram of the POIN Datastore in the computing device of FIG. 2.

FIG. 4 is a functional block diagram of an exemplary Mobile Device computing device and some data structures and/or components thereof.

FIG. 5 is a functional block diagram of the Mobile Device Datastore in the computing device of FIG. 4.

FIG. 6 is a functional block diagram of an exemplary Network Controller computing device and some data structures and/or components thereof.

FIG. 7 is a functional block diagram of the Network Controller Datastore in the computing device of FIG. 6.

FIG. 8 is a flowchart illustrating a process in which Network Reports and Device Reports are obtained and correlated, in which additional devices are associated with a Mobile Device's Device Identifier, in which behavioral information is obtained from devices associated with a Device Identifier, and in which Mobile Content is Optimized based on behavioral patterns.

FIG. 9 is an example of a subroutine illustrated in FIG. 8, in which a Network Report is received and processed.

FIG. 10 is an example of a subroutine illustrated in FIG. 8, in which a Device Report is received and processed.

FIG. 11 is an example of a subroutine illustrated in FIG. 8, in which a Network Report and Device Report are correlated and a Device ID assigned.

### DETAILED DESCRIPTION

The following description provides specific details for an understanding of various examples of the technology. One skilled in the art will understand that the technology may be practiced without many of these details. In some instances, structures and functions have not been shown or described in detail or at all to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list. References are made herein to routines and subroutines; generally, it should be understood that a routine is a software program executed by computer hardware and that a subroutine is a software program executed within another routine. However, routines discussed herein may be executed within another routine and subroutines may be executed independently (routines may be subroutines and visa versa).

Certain elements appear in various of the Figures with the same capitalized element text, but a different element number. When referred to herein with the capitalized element text but with no element number, these references should be understood to be largely equivalent and to refer to any of the elements with the same capitalized element text, though potentially with differences based on the computing device within which the various embodiments of the element appears.

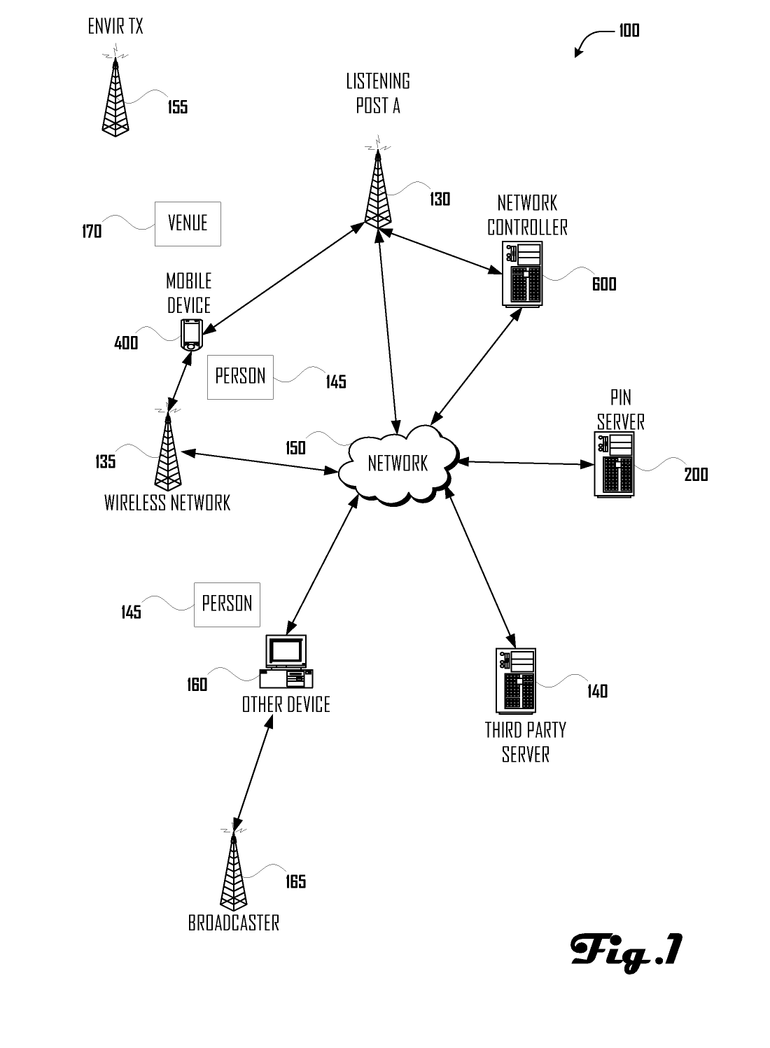

FIG. 1 is a network and device diagram illustrating exemplary computing devices configured according to embodiments disclosed in this paper. In FIG. 1, a Mobile Device 400 computer is illustrated. The Mobile Device 400 may be, for example, a mobile phone, a smart phone, a tablet computer, a laptop computer, or similar. The Mobile Device 400 is illustrated as connecting to a Wireless Network 135 and forming a network connect with or being detected by a Listening Post 130. The Listening Post 130 may be, for example, a WIFI base station, an LTE base station, an eNodeB (or “Evolved Node B”) or a similar computer-driven wireless transceiver capable of receiving, in data packets, a MAC Address transmitted by a Mobile Device 400. As used herein, a “MAC Address” refers to a “media access control address” or “medium access control address” or to another unique identifier assigned to a network interface, such as by the manufacturer of a network interface controller (“NIC”) or similar, for communication on the physical network segment, such as in the media access control protocol sublayer of the OSI reference model, often stored in read-only memory of a computer; a MAC Address, as used herein, may also be referred to as a “burned-in address” and may be contrasted with a programmed or arbitrarily assigned address. MAC Addresses are utilized by or in, for example, Ethernet and other IEEE 802.11 networks, most other IEEE 802 networks, IPv6 networks, LTE, and LTE-Advanced networks. The Wireless Network 135 may be, for example, a cellular telephone network (such as, for example, a GSM, CDMA, EDGE, or LTE network) capable of providing voice, text, and data services. The Mobile Device 400 may also have another connection path (not shown) to the Network 150 (such as a wireline connection). The connection between the Mobile Device 400 and the Listening Post 130 may be one way, such as, for example, when the Listening Post 130 is a base station for a WIFI or LTE network and the Mobile Device 400 includes an active transceiver and supporting communication routines, which routines and transceiver transmit data packets detected by Listening Post 130, but wherein a network connection is not formed between the Mobile Device 400 and the Listening Post 130. The connection between the Mobile Device 400 and the Listening Post 130 may also be two way, such as when a network connection between the Mobile Device 400 and the Listening Post 130 is formed. As discussed further herein, the Mobile Device 400 may utilize the network connection with the Wireless Network 135 and/or the Listening Post 130 and the Network Controller 600 to send Device Reports 510 to the POIN Server 200.

The Wireless Network 135 may form a network connection with the Network 150. The Listening Post 130 may form a network connection (such as an Ethernet or other packet network connection) with a Network Controller 600 and/or with or to the Network 150, while the Network Controller 600 connects to the Network 150. The Network Controller 600 may, for example, coordinate network traffic and network utilization as Mobile Devices move relative to WIFI or other base stations (such as Listening Post 130); the Network Controller 600 may also, for example, monitor a set of WIFI base stations (such as Listening Post 130), the availability thereof and other aspects of the network services provided by such base stations. Commercial examples of Network Controller 600 include the MOTOROLA AIRDEFENSE SOLUTIONS, provided by Motorola, Inc., and the CISCO MOBILITY SERVICES ENGINE, provided by Cisco, Inc. As discussed further herein, the Network Controller 600 connects to the Network 150 to send Network Reports 705 to the POIN Server 200. The connection between the Network Controller 600 and the POIN Server 200 may be secure and may require authentication and authorization between the components.

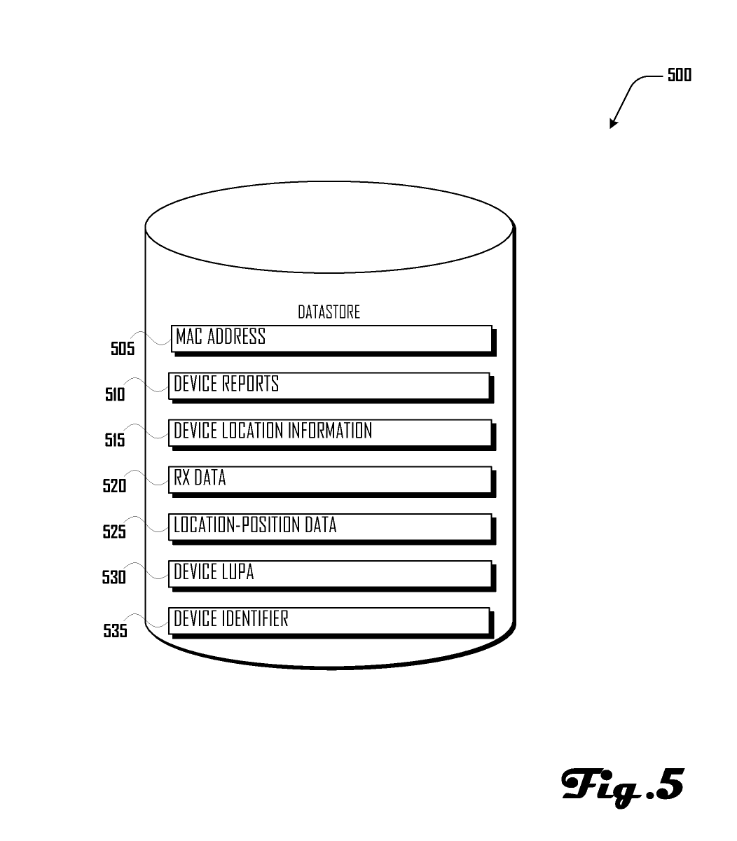

The Mobile Device 400 is also illustrated as being within detecting distance of an Environmental Transmitter 155 (“Envir TX 155”). The Envir TX 155 may be any emitter of radio frequency energy, such as, for example, a WIFI base station, a cellular network (such as Wireless Network 135), a broadcaster (such as Broadcaster 165), a satellite (including a GPS satellite, a satellite television broadcaster, or similar). The Mobile Device 400 may form a network connection with the Envir TX 155 or may detect the radio frequency energy emitted by the Envir TX 155. As discussed herein, the Mobile Device 400 may detect the radio frequency emitted by the Envir TX 155 and may record the characteristics thereof, such as the frequencies utilized, the power level detected, an encoding format of information encoded in the radio frequency energy, and some or all information transmitted by the radio frequency energy, such as, for example, an identifier of the Envir TX 155. Information regarding the radio frequency energy detected by the Mobile Device 400 may be recorded in, for example, the RX Data 520 record, illustrated in FIG. 5, which record may be part of a Device Report 510.

The Network 150 comprises computers, network connections among the computers, and software routines to enable communication between the computers over the network connections. Also connected to the Network 150 is an Other Device 160. The Other Device 160 may be, for example, a personal computer, a tablet computer, a laptop, a television, a radio, an ebook reader, or another computer capable of rendering audio or visual media. The Other Device 160 may be implemented by a computer similar to the Mobile Device 400. The Other Device 160 is illustrated as connecting to the Network 150 and a Broadcaster 165, such as television, radio, or satellite broadcaster (the Other Device 160 may not have both such connections). The Mobile Device 400 and the Other Device 160 are illustrated as being proximate to and being used by a Person 145. The Person 145 is meant to be the same person at the same or at different times (the Mobile Device 400 may be proximate to the Other Device 160), though the Person 145 may also represent different people.

Also illustrated in FIG. 1 is the POIN Server 200. As discussed further herein, the POIN Server 200 receives Device Reports 510 from the Mobile Device 400 and Network Reports 705 from the Network Controller 600. The POIN Server 200 may store these as Network Reports 305 and Device Reports 320.

Also illustrated in FIG. 1 is a Third Party Server 140 connected to the Network 150. The Third Party Server 140 represents, for example, online services, such as social network services, and other online services. Such services shall be referred to herein as “Online Services.” The Third Party Server 140 may be implemented by a computer similar to the POIN Server 200.

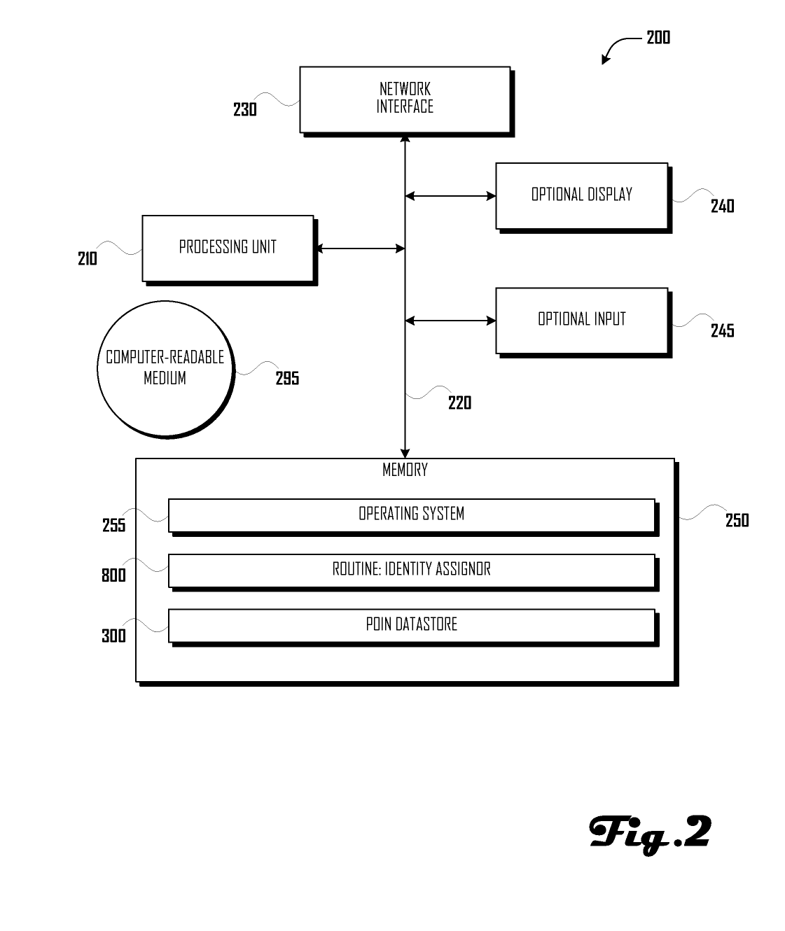

Computers capable of implementing the POIN Server 200, the Mobile Device 400, and the Network Controller 600, also referred to together herein as a “Computing Device” or as “Computing Devices,” are further illustrated in FIGS. 2, 4, and 6, respectively. These Figures illustrate these computers as comprising a datastore, such as POIN Datastore 300, Mobile Device Datastore 500, and Network Controller Datastore 700. This paper may discuss components as connecting to the POIN Server 200, the Mobile Device 400, and the Network Controller 600 or to the Datastore for such device; it should be understood that such connections may be to, through, or via the other of the two components (for example, a statement that a computing device connects with or sends data to the POIN Server 200 should be understood as saying that the computing device may connect with or send data to the POIN Datastore 300). References herein to “database” should be understood as equivalent to “Datastore.” Although illustrated in these Figures as components integrated in one physical unit, the computers, servers and databases may be provided by common (or separate) physical hardware and common (or separate) logic processors and memory components.

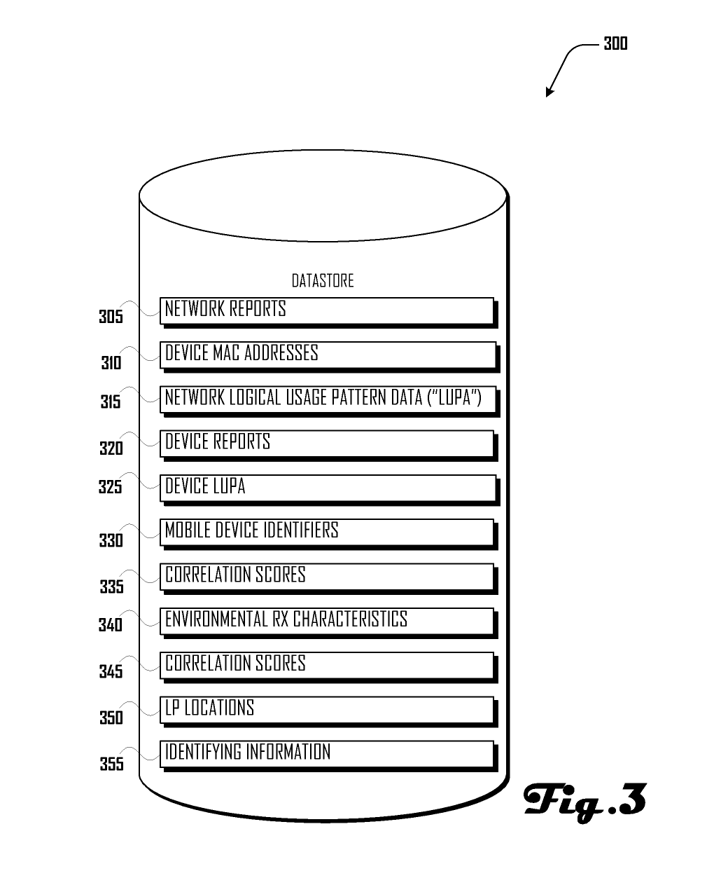

The computers illustrated in FIG. 1 are further illustrated in FIGS. 3, 5, and 7 as comprising data groups for routines and data groups used by routines. In addition to the data groups explicitly illustrated, additional data groups may also be present on and/or executed by these devices, such as routines for databases, webservers, and web browsers, and routines to enable communication with other computers. The data groups used by routines may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar. The browser routines may provide an interface for interacting with other computers through, for example, a webserver routine (which may serve data and information in the form of webpages). The web browsers and webservers are meant to illustrate or refer to user-interface and user-interface enabling routines generally, and may be replaced by equivalent routines for serving and rendering information to and in a user or device interface. Login credentials and local instances of user or device profiles may be stored in or be accessible to the Mobile Device 400, the POIN Server 200, the Other Device 160, the Network Controller 600, and the Third Party Server 140. Such user or device profiles may be utilized to provide secure communication between the computers.

The software routines and data groups used by the software routines may be stored and/or executed remotely relative to any of the computers through, for example, application virtualization.

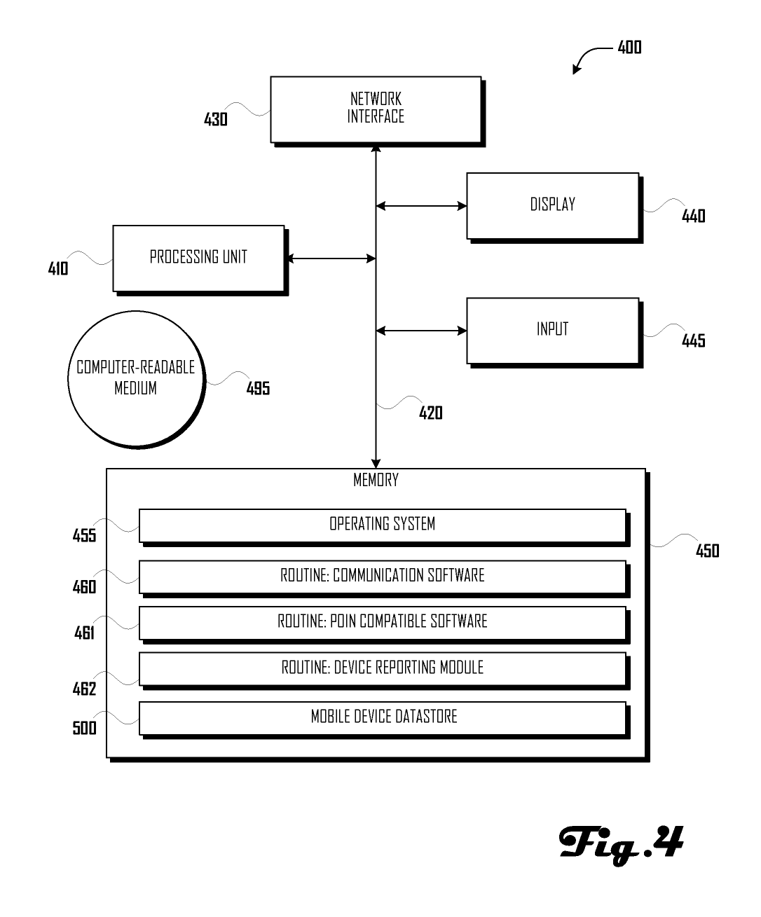

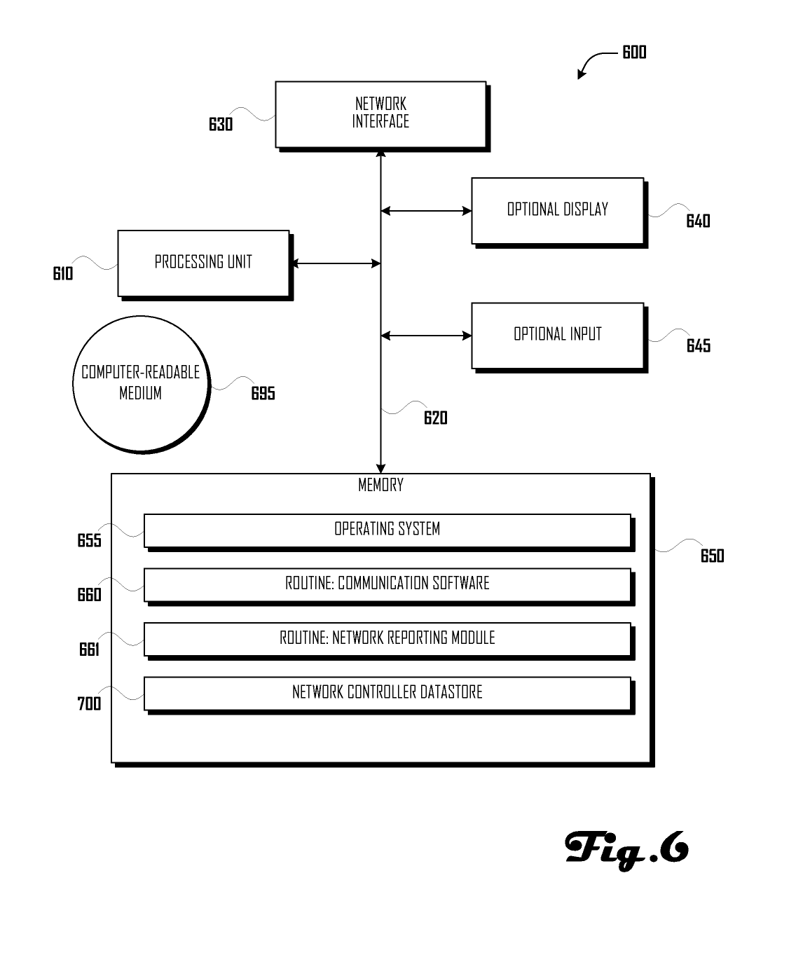

FIG. 2 is a functional block diagram of an exemplary POIN Server computing device and some data structures and/or components thereof. FIG. 4 is a functional block diagram of an exemplary Mobile Device computing device and some data structures and/or components thereof. FIG. 6 is a functional block diagram of an exemplary Network Controller computing device and some data structures and/or components thereof. The following discussion is directed to all of these Figures, with some differences noted.

In some embodiments, the Computing Device illustrated in FIGS. 2, 4, and 6 (POIN Server 200, Mobile Device 400, and Network Controller 600) may include many more components than those shown. However, it is not necessary that all of these generally conventional components be shown in order to disclose an illustrative embodiment.

As shown in these Figures, the Computing Device includes a Network Interface for connecting to the Network 150. The Computing Device also includes at least one Processing Unit, Memory, and either an Optional Display (such as Optional Display 240 or 640) or a Display (such as Display 440), all interconnected along with the Network Interface via a Bus (220, 420, or 620). The Memory generally comprises a random access memory (“RAM”), a read only memory (“ROM”), and a permanent mass storage device, such as a disk drive or SDRAM (synchronous dynamic random-access memory). The Memory stores program code for software routines. In the case of the POIN Server 200, the routines include, for example, the Identity Assignor routine 800. In the case of the Mobile Device 400, the routines include, for example, Communication Software 460 routine(s) (such as software which enables communication through at least layers one through five of the Open System Interconnection (OSI) model; the other devices may also include this software), POIN Compatible Software 461 routines (which may include, for example, a barcode scanner routine, a shopping list service routine, a search service routine, a routing service routine (for finding routes between locations), a location and position recording routine, and an environmental radio frequency energy sensing and recording routine), and a Device Reporting Module 462 routine (which sends Device Reports to the POIN Server 200). In the case of the Network Controller 600, the routines include, for example, Communication Software 660 routine(s) (such as software which enables communication through at least layers one through five of the Open System Interconnection (OSI) model; the other devices may also include this software) and a Network Reporting Module 461 routine (which sends Network Reports to the POIN Server 200).

In addition, the Memory also stores an Operating System. These software components may be loaded from a non-transient Computer Readable Storage Medium into Memory of the Computing Device using a drive mechanism (not shown) associated with a non-transient Computer Readable Storage Medium, such as a floppy disc, tape, DVD/CD-ROM drive, memory card, or other like storage medium. In some embodiments, software components may also or instead be loaded via a mechanism other than a drive mechanism and Computer Readable Storage Medium (e.g., via Network Interface).

The Computing Device may also comprise hardware supporting optional input modalities, Optional Input 225 and 645 and Input 425, such as, for example, a touchscreen, a keyboard, a mouse, a trackball, a stylus, a microphone, transmit and receive antennae (to the extent not considered part of the Network Interface), and a camera.

Computing Device also comprises or communicates via Bus with Datastore, illustrated further in FIGS. 3, 5, and 7. In various embodiments, Bus may comprise a storage area network (“SAN”), a high speed serial bus, and/or via other suitable communication technology. In some embodiments, Computing Device may communicate with Datastore via Network Interface.

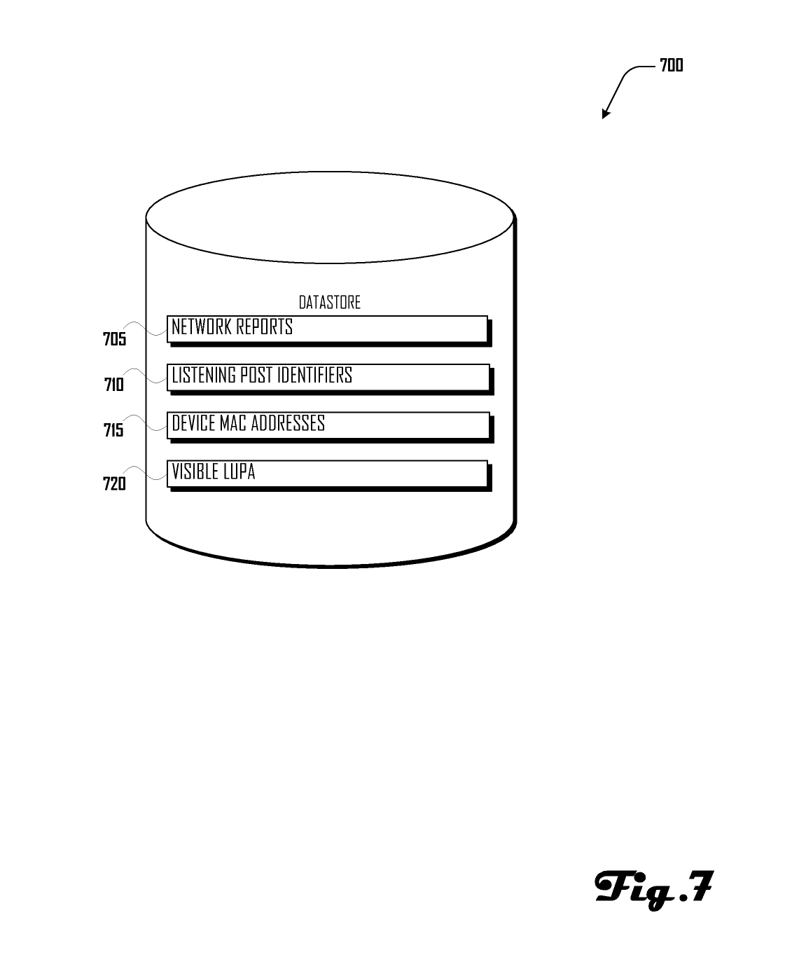

FIG. 3 is a functional block diagram of the POIN Datastore in the computing device of FIG. 2. FIG. 5 is a functional block diagram of the Mobile Device Datastore in the computing device of FIG. 4. FIG. 7 is a functional block diagram of the Network Controller Datastore in the computing device of FIG. 6. These Figures illustrate data groups used by routines; these data groups are discussed further herein.

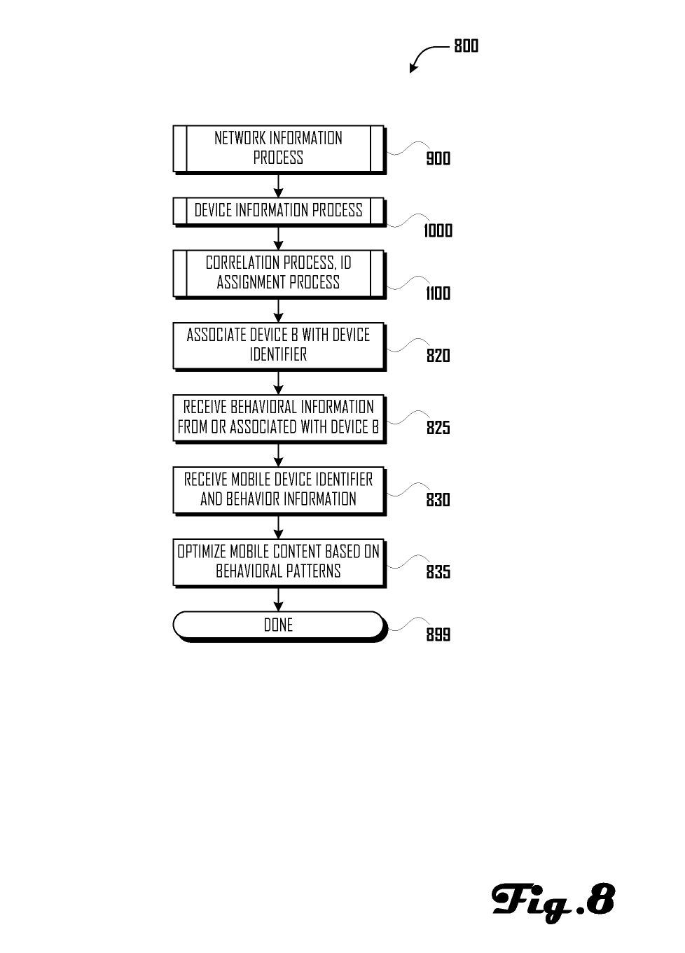

FIG. 8 is a flowchart illustrating a process in which Network Reports and Device Reports are obtained and correlated, in which additional devices are associated with a Mobile Device's Device Identifier, in which behavioral information is obtained from devices associated with a Device Identifier, and in which Mobile Content is Optimized based on behavioral patterns.

The steps in FIG. 8 are generally performed by the POIN Server 200, in conjunction with the other computers illustrated in FIG. 1. At step 900, a Network Information Process 900 subroutine executes and obtains and processes Network Reports from the Network Controller 600.

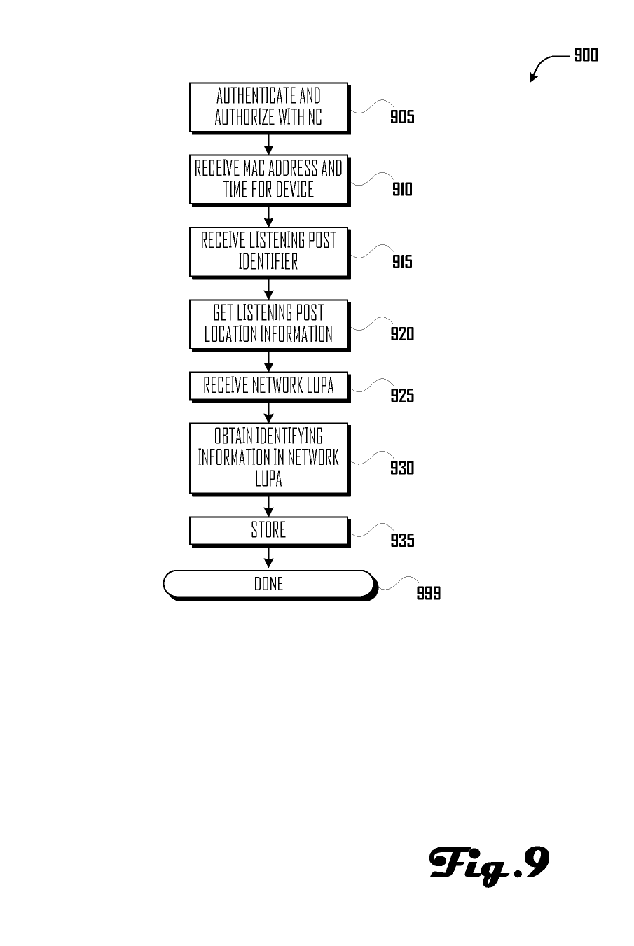

Referring to FIG. 9 as an example, the POIN Server 200 may, at step 905, authenticate and authorize with the Network Controller 600. The Network Controller 600 may be executing a Network Reporting Module 661 and/or the Network Controller 600 may be responsive to commands from the POIN Server 200. The Network Reporting Module and/or the commands from the POIN Server 200 may cause the Network Controller 600 to transmit a Network Report to the POIN Server 200. The Network Reports comprise a Device MAC Address 715 (obtained from MAC Address 505 of a mobile computing device, such as the Mobile Device 400), and a timestamp indicating the time when the MAC Address was obtained. The Device MAC Address 715 may be provided, for example, by the Mobile Device 400 to the Listening Post 130, such as by the Communication Software 461 in the Mobile Device to the Communication Software 660 in the Network Controller 600. The Mobile Device 400 may transmit this information to all devices in its proximity, including to the Listening Post 130, as the Mobile Device 400 transits an area and attempts (often programmatically) to identify WIFI base stations which may be available to form a network connection; the Mobile Device 400 and the Listening Post 130 may form a network connection. The Mobile Device 400 may thus communicate the MAC Address 505 regardless of whether it forms a network connection with the Listening Post 130.

The Network Report may further comprise an identifier of the network node (such as Listening Post Identifiers 710) which detected the MAC Address and which communicated the MAC Address to the Network Controller 600, and which is likely to be proximate to the Mobile Device 400. In FIG. 9, this is illustrated at step 915, where a Listening Post Identifier 710 is received. At step 920 in FIG. 9, the POIN Server may obtain location information associated with the Listening Post. This information may be obtained by looking up the Listening Post Identifier 710 in a table or against database entries, such as against LP Locations 350, which may list Listening Post Identifiers 710 in association with locations, such as latitude, longitude, and elevation, address, or similar. This information may also be received from other sources, such as from the Network Controller 600.

At step 925, “Network LUPA” is received. “Network LUPA” may comprise, for example, logical usage pattern data (“LUPA”) as detected by, for example, the Listening Post 130. The Network LUPA may be stored, for example, in Visible LUPA 720 records in the Network Controller 600 or as Network LUPA 315 in the POIN Server 200.

At step 930 (which, as other steps, may be optional) identifying information may obtained from the Network LUPA 315. The Network LUPA may comprise Identifying Information 355 such as, for example, externally visible or readable information (“visible” because it is, for example, unencrypted, or encoded according to a known and identifiable process, or because, for example, the POIN Server 200 has the decryption key or can execute a process to decode the information), which information may be input by the Person 145 into a routine executing on the Mobile Device 400 (such as into a search routine, a shopping list service routine, or into a POIN Compatible Software 461 software application), or produced or output by a routine executing on the Mobile Device 400 (such as a URL), or information returned to the Mobile Device 400, such as a network address. The Identifying Information 355 may comprise, for example, information such as, “Where are the chocolate cookies,” or a scan of a barcode (or the result thereof), or a search for a location, or the addition of an item to a shopping list, a URL, a network address, a geofence trigger event, and similar. While not part of the Network LUPA, the same or similar information may be received from or be identified in the Device LUPA. The Identifying Information 355 may be obtained by parsing the Network LUPA 315 for fields known or expected to contain Identifying Information 355; obtaining the Identifying Information 355 may be performed by the Network Controller 600 or by the POIN Server 200.

At step 935 the Identifying Information 355 may be stored, for example, as separate records or as part of Network Reports 305 in the POIN Server 200.

Returning to FIG. 8, at step 1000, a Device Information Process 1000 subroutine may execute and obtain and process Device Reports from the Mobile Device 400.

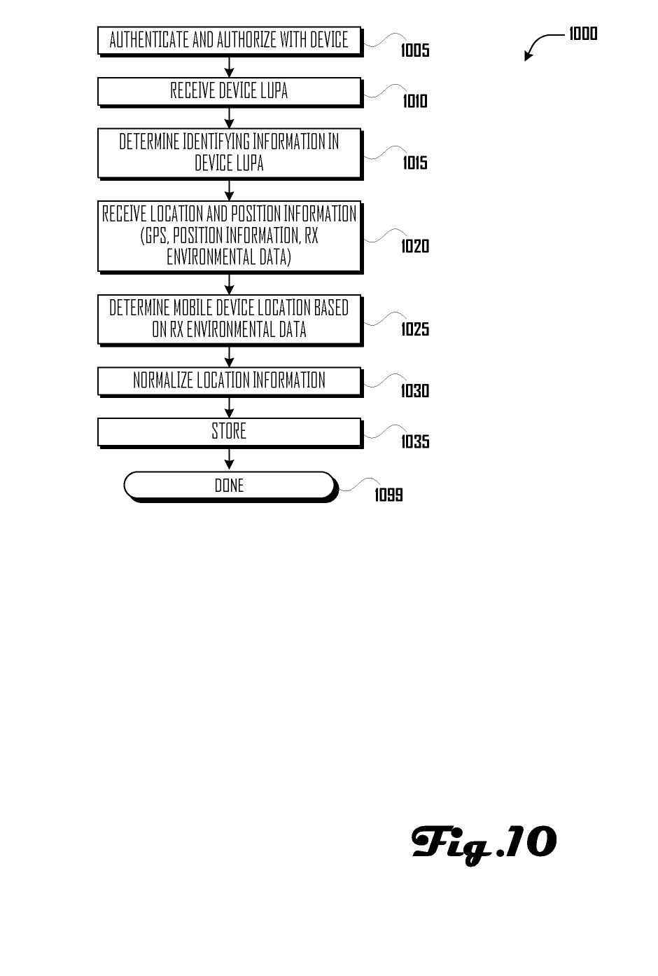

Referring to FIG. 10, which illustrates an embodiment of the Device Information Process 1000, the POIN Server 200 may, at step 905, authenticate and authorize with the Mobile Device 400. The Mobile Device 400 may be executing a Device Reporting Module 462. The Device Reporting Module 462 may cause the Mobile Device to transmit Device Reports 510 to the POIN Server 200. Receipt of the Device Reports 510 is illustrated in FIG. 10 by steps 1010 and 1020, illustrating receipt of Device LUPA 325 at step 1010 and receipt of location and position information at step 1020, though the information illustrated in these steps may be received in one or more Device Reports 510 (which do not have to be received in the order shown in FIG. 10). The Device Reports may comprise Device Location Information 515 (which may comprise Location-Position Data 525 and RX Data 520) and Device LUPA 530, and one or more timestamps associated therewith. The Device Reporting Module 462 may comprise one or more routines (or subroutines) which are executed by a special-purpose module or by other routines. The Mobile Device 400 may comprise POIN Compatible Software 461, which may comprise routines (or subroutines) which transmit Device Reports 510 to the POIN Server 200 (fulfilling the role of Device Reporting Module 462). As discussed above, the POIN Compatible Software 461 may comprise routines such as, for example, a barcode scanner routine, a shopping list service routine, a search service routine, a routing service routine (for finding routes between locations), and a location and position determining and/or recording routine (which may collect Device Location Information 515). The Device LUPA 530 may comprise information the same as or similar to the Network LUPA 315, discussed above. The Device LUPA 530 may comprise, for example, information such as, “Where are the chocolate cookies,” or a scan of a barcode (or the result thereof), or a search for a location, or the addition of an item to a shopping list, a URL, or a network address, a geofence trigger event, and similar. The Device LUPA 530 may be encrypted or obfuscated.

At step 1015, the Device LUPA 530 may be processed to obtain Identifying Information 355, as discussed above in relation to step 930 in FIG. 9.

As noted above, at step 1020, the Mobile Device 400 location, position, and orientation information may be received. The location information may be received from, for example, a GPS sensor in the Mobile Device 400 or from a location-service to which the Mobile Device 400 subscribes (which location may be reported by the location-service to the Mobile Device 400 which then reports it to the POIN Server 200 or which location may be reported by the location-service to the POIN Server 200). The Mobile Device 400 may also include position and orientation sensors (such as compass, accelerometers, and similar) and may also provide this information in the Device Reports 510.

If not already performed by a location-service (or in addition to a location provided by a location-service), at step 1025, the RX Data 520 may be processed to determine the location of the Mobile Device 400, such as by, for example, determining a radius of the Mobile Device 400 relative a radio frequency emitter, such as Envir TX 155. This step may be performed by looking up the identity of the emitter based on the RX Data 520 (such as based upon an identifier of the Envir TX 155, a frequency used by the Envir TX 155, or similar, in the RX Data 520) in the Environmental RX Characteristics 340 records and determining or looking up a radius relative to the emitter at which the RX Data 520 may have been detected (such as according to a power level); this step may calculate the attenuation of the radio frequency energy from the emitter, taking into account the geographic and topologic characteristics of the environment around the emitter; this step may be performed by looking up known, previously recorded and/or previously calculated, power levels around the emitter. This step may involve determining the radius of the Mobile Device 400 relative to two or more emitters and determining where the radii overlap. If three or more emitters are recorded in the RX Data 520 (which emitters have corresponding entries in the Environmental RX Characteristics 340 record), this step may involve trilaterating or triangulating the position of the Mobile Device 400 relative to the emitters.

At step 1030 the location information received in or determined from information received in the Device Reports 510 may be normalized relative to a coordinate system utilized by the POIN Server 200, such as a latitude, longitude, and elevation scheme, a geodetic scheme relative to a building, or relative to another location system utilized by the POIN Server 200. For example, an address may be converted to latitude and longitude. At step 1035 the information may be stored, for example, as part of Device Reports 320 in the POIN Server 200.

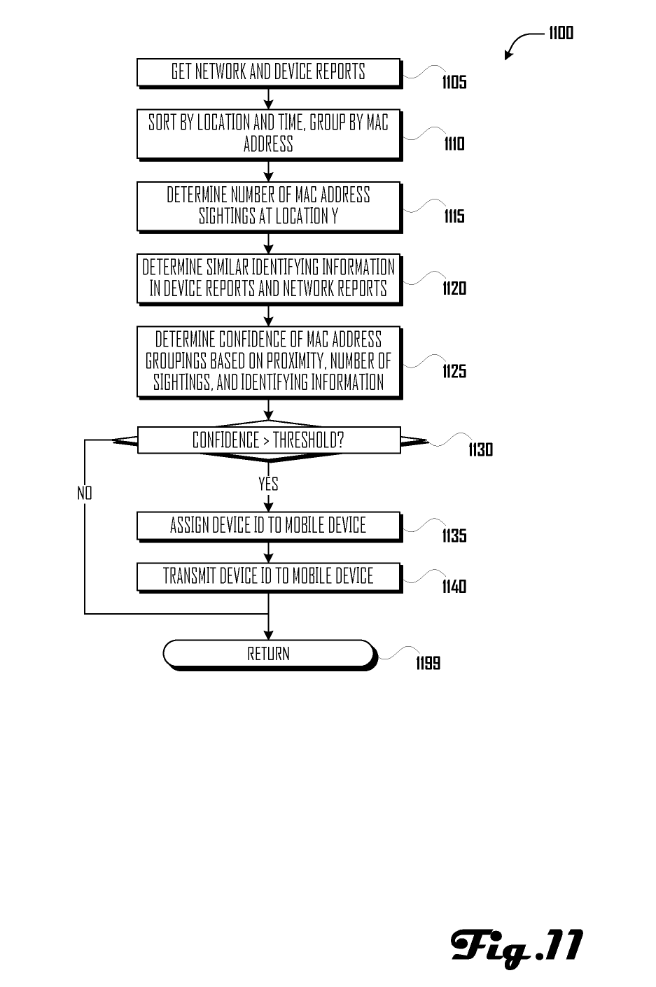

FIG. 11 is an example of a subroutine illustrated in FIG. 8, in which a Network Report and Device Report are correlated and a Device ID assigned. At step 1105, the Network Reports 305 and Device Reports 320 may be obtained (if they are not already in memory). At step 1110 the Network Reports 305 and Device Reports 320 may be sorted by location and time and with the records further grouped by MAC Address (in the Network Reports 305). At step 1115, the number of MAC Address sightings at location Y or within a range of location Y may be determined. At step 1120, similar or identical Identifying Information 355 in the Network Reports 305 and the Device Reports 320 (as may have been obtained from Device LUPA 325 and Network LUPA 315) may be identified.

At step 1125, the confidence of the MAC Address groupings may be determined based on, for example, the number of sightings of the MAC Address at or near the location Y, the proximity of the location information in the Network Reports 305 and the Device Reports 320, the number of matches between the Identifying Information 355 in the Network Reports 305 and the Device Reports 320, matches between the Identifying Information 355 in the Network Reports 305 and the Device Reports 320 and information associated with locations in the Network Reports 305 and the Device Reports 320 (such as if the Identifying Information 355 in a Device Report 320 includes a search for cookies and location in a Network Report 305 is proximate to a store selling cookies). The confidence determined at step 1125 may be stored as Correlation Score 335.

At step 1130, if the confidence determined at step 1125 is above a threshold, then at step 1135 an identifier may be assigned to the Mobile Device 400 and stored as Mobile Device Identifier 330. At step 1140, the identifier may be transmitted to the Mobile Device 400, such as in the form of a cookie or another identifying record. The identifier may be stored at the Mobile Device 400 as a Device Identifier 535 record. The process may then return to FIG. 8. The Device Identifier 535 may then be transmitted by the Mobile Device 400 to identify the Mobile Device 400.

Returning to FIG. 8, at optional step 820, a “Device B,” such as Other Device 160, may be associated with the Mobile Device Identifier 330 assigned to the Mobile Device 400. Association of the Mobile Device Identifier 330 to the Device B may be based, for example, on information that Mobile Device 400 and Device B are owned or used by the same person, such as Person 145; this association may also be based on proximity over time, such as observed proximity of Mobile Device 400 to Device B. At optional step 825, behavioral information associated with Device B may be received. This behavioral information may comprise, for example, television, radio, or other media consumption information, including exposure to advertisements.

At step 830, the Device Identifier 535 may be received in conjunction with behavioral information, which behavioral information may include a location of the Mobile Device 400, which location may be a location proximate to a venue, such as Venue 170, at which products or services may be obtained. At step 835, content served to the Mobile Device 400 may be optimized based on, for example, the location of the Mobile Device 400 relative to the venue. The content served to the Mobile Device 400 may further be optimized based on, for example, the behavioral information received at step 825, such as by, for example, serving advertisements to the Mobile Device 400 which compete with or reinforce advertisements served to Person 145 at Device B and which relate to products or services available at the venue.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A method of determining the identity of a mobile computing device in a computer comprising a memory, the method comprising:
receiving a mobile device report, which mobile device report comprises: a time and at least one of mobile device location information and identifying information;
receiving a network device report, which network device report comprises:
a MAC address of a mobile computing device, an identifier of a network node, and time;
obtaining network node location information;
determining a correlation score between the mobile device report and the network report; and
when the correlation score is above a threshold, assigning an identifier to the mobile computing device.

2. The method of claim 1, wherein the identifying information in the mobile device report further comprises logical usage pattern data.

3. The method of claim 2, wherein the logical usage pattern data is information input into a routine in the mobile computing device by a user thereof or information returned to or produced by the routine in the mobile computing device in response to information input into the mobile device by the user thereof.

4. The method of claim 3, wherein the routine in the mobile computing device is one of a search routine, a shopping list routine, a routing routine, and a barcode scanner routine.

5. The method of claim 2, further comprising identifying in the logical usage pattern data at least one of a search for information, location information, a product or service, and a barcode.

6. The method of claim 1, wherein the mobile device location information comprises one of latitude and longitude.

7. The method of claim 1, wherein the mobile device location information comprises environmental radio frequency information detected by the mobile device and further comprising determining a location of the mobile device based on the environmental radio frequency information.

8. The method of claim 7, wherein determining a location of the mobile device based on the environmental radio frequency information comprises obtaining an identifier associated with the radio frequency information, obtaining a location of an emitter of the radio frequency energy based on the identifier, and triangulating or trilaterating the location of the mobile device based on the location of the emitters of the radio frequency information.

9. The method of claim 1, wherein the mobile device report further comprises position and orientation information.

10. The method of claim 1, further comprising normalizing the network node location information to a standard location coordinate system.

11. The method of claim 1, wherein determining a correlation score comprises sorting the network device reports and the mobile device reports by time and location.

12. The method of claim 11, further comprising grouping the network device reports by MAC address.

13. The method of claim 12, wherein determining a correlation score comprises increasing the correlation score when the mobile device report and the network device report comprise proximate locations at proximate times.

14. The method of claim 1, wherein the network device report comprises identifying information of the mobile device.

15. The method of claim 14, wherein the identifying information of the mobile device in the network device report is information which is not encrypted or obfuscated.

16. The method of claim 14, further comprising determining that at least some of the identifying information from the mobile device report and from the network device report is the same and wherein determining a correlation score comprises increasing the correlation score when the identifying information from the mobile device report and from the network device report is the same.

17. The method of claim 1, wherein the mobile device report is received from a mobile device.

18. The method of claim 1, wherein the network device report is received from a network controller.

19. The method of claim 1, wherein information in the network device report is generated by at least one of a WIFI base station and an LTE base station.

20. The method of claim 1, wherein the network node location information is a location of a computing device which detected the mobile computing device.

21. The method of claim 1, wherein the identifier of a network node is the identifier of a network node which detected the MAC address at a time when the network node and the mobile device are proximate.

22. The method of claim 1, further comprising associating the identifier of the mobile computing device with a computing device other than the mobile computing device, receiving behavioral information associated with the computing device other than the mobile computing device, optimizing content based on the behavioral information, and transmitting the optimized content to the mobile computing device.

23. The method of claim 22, wherein the behavioral information comprises information regarding an advertisement transmitted to the computing device other than the mobile computing device and wherein optimizing content based on the behavioral information comprises selecting content which competes with or reinforces the advertisement.

24. A computer system with a computer readable medium comprising instructions which, when executed, perform the method according to claim 1.
